(19) United States
(12) Patent Application Publication
(10) Pub. No.: US 2012/0231647 A1
(43) Pub. Date: Sep. 13, 2012

(54) ELECTRICAL CARD CONNECTOR

(75) Inventors: JIAN-FEI YU, Kunshan (CN); FANG-YUE ZHU, Kunshan (CN); QI-JUN ZHAO, Kunshan (CN)

(73) Assignee: HON HAI PRECISION INDUSTRY CO., LTD., New Taipei (TW)

(21) Appl. No.: 13/414,741

(22) Filed: Mar. 8, 2012

(30) Foreign Application Priority Data
Mar. 8, 2011 (CN) 201120058063.4

(51) Int. Cl. H01R 13/62; H01R 43/00

(52) U.S. Cl. 439/325; 29/825

(57) ABSTRACT

An electrical card connector (100) includes an insulative housing (1), a plurality of contacts (2) retained in the insulative housing (1), and a mounting member (3) disposed on the insulative housing (1). The insulative housing (1) defining a receiving space (110). The mounting member (3) includes a first metal plate (31) defines an elastic plate (312) protruding into the receiving space (110) for abutting against the electrical card (200) when the electrical card (200) is inserted into the receiving space (110). The electrical card (200) can be fixed reliably and withdrawn from the electrical card connector (100) conveniently in virtue of the elastic plate (312).

### BACKGROUND OF THE INVENTION

1. Field of the Invention

The present invention generally relates to an electrical card connector and more particularly to an electrical card connector having a mounting member for positioning and locating the electrical card reliably and securely within the connector.

2. Description of Related Art

Chinese patent application publication No. CN101783453A, published on Jul. 21, 2010, discloses a conventional electrical card connector including an insulative housing, and a plurality of contacts retained in the insulative housing. The insulative housing comprises a receiving space and a step portion in a front of the receiving space, and a metal plate is attached upon the step portion to cover a top of the receiving space and extends backwardly from the step portion. The receiving space comprises a front receiving portion located below the step portion and a front accommodating portion located below the metal plate. The step portion abuts downwardly against the electrical card to prevent the electrical card from moving upwardly when the electrical card is inserted into the front receiving portion in a downward and aslantly manner. Then, the electrical card passes over the front receiving portion and is inserted into the front accommodating portion. The metal plate prevents the electrical card from moving upwardly and a rear of step portion prevents the electrical card from moving forwardly. But the electrical card connector abuts against the step portion with a non-obedient force, so the electrical card would be jammed unreliably and it may be inconveniently withdrawn from the electrical card connector.

Other objects, advantages and novel features of the present invention will become more apparent from the following detailed description of the present embodiment when taken in conjunction with the accompanying drawings.

### SUMMARY OF THE INVENTION

The present invention provides an electrical card connector comprises an insulative housing having a receiving space for receiving an electrical card and a front wall located in front of the receiving space, a plurality of contacts retained in the insulative housing and a mounting member. Each of contacts comprises a contacting portion extending into the receiving space and a soldering portion extending out of the insulative housing. The mounting member comprises a first metal plate retained to the insulative housing, the first metal plate has an elastic plate disposed in a front of the receiving space and extending backwardly in the receiving space for resisting a front portion of the electrical card.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is an assembled perspective view of an electrical card connector according to a presently preferred first embodiment of the present invention, showing an electrical card inserted in the electrical card connector;

FIG. 2 is another perspective view of the electrical card connector and the electrical card as shown in FIG. 1;

FIG. 3 a top view of the electrical card connector as shown in FIG. 2;

FIG. 4 an exploded view of the electrical card connector as shown in FIG. 2;

FIG. 5 is a perspective view of a first metal plate of the electrical card connector according to a preferred embodiment of the present invention;

FIG. 6 is a cross-sectional view of the electrical card connector, showing the electrical card aslant inserting into the electrical card connector.

FIG. 7 is another cross-sectional view of the electrical card connector, showing the electrical card just horizontally put in the electrical card connector.

FIG. 8 is a cross-sectional view of the electrical card connector taken along line 8-8 of FIG. 1, showing the electrical card arriving a final position in the electrical card connector.

FIG. 9 is a perspective view of the first metal plate of a second embodiment of the electrical card connector.

FIG. 10 is a partial enlarged cross-sectional view of the electrical card connector of FIG. 9, showing interrelation among the electrical card, the resilient arm and the stationary abutment piece when the electrical card arrives at a final position in the electrical card connector.

### DETAILED DESCRIPTION OF THE INVENTION

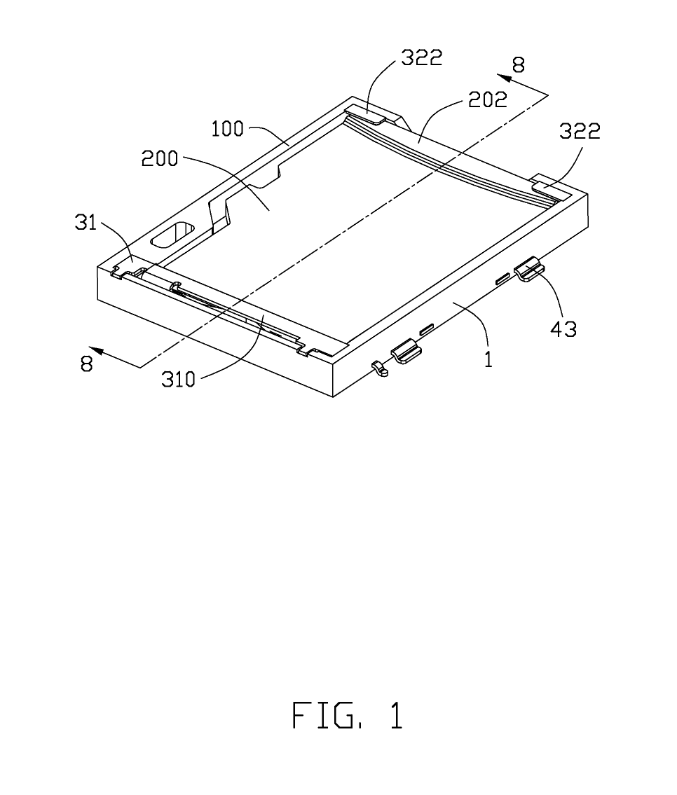

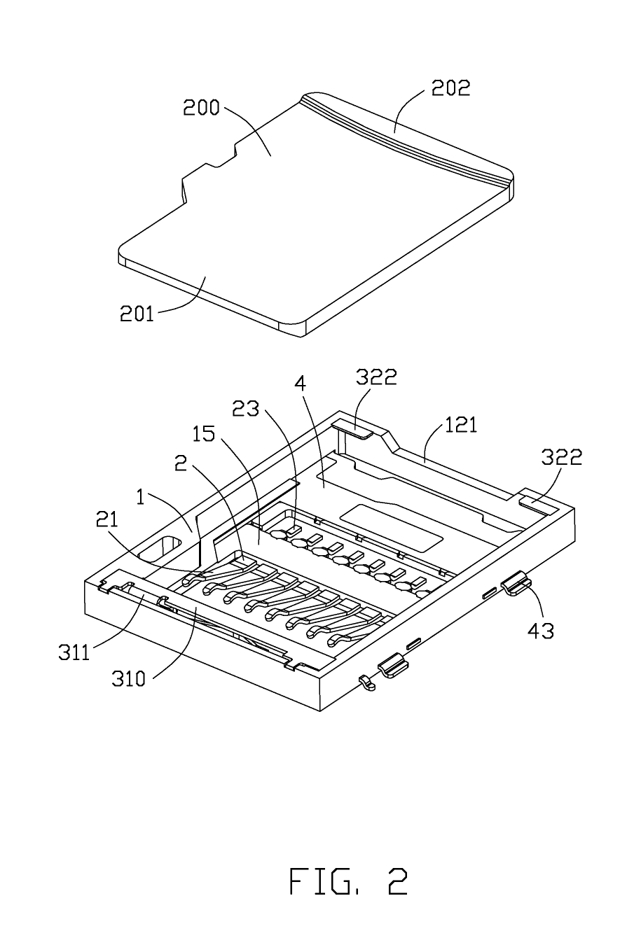

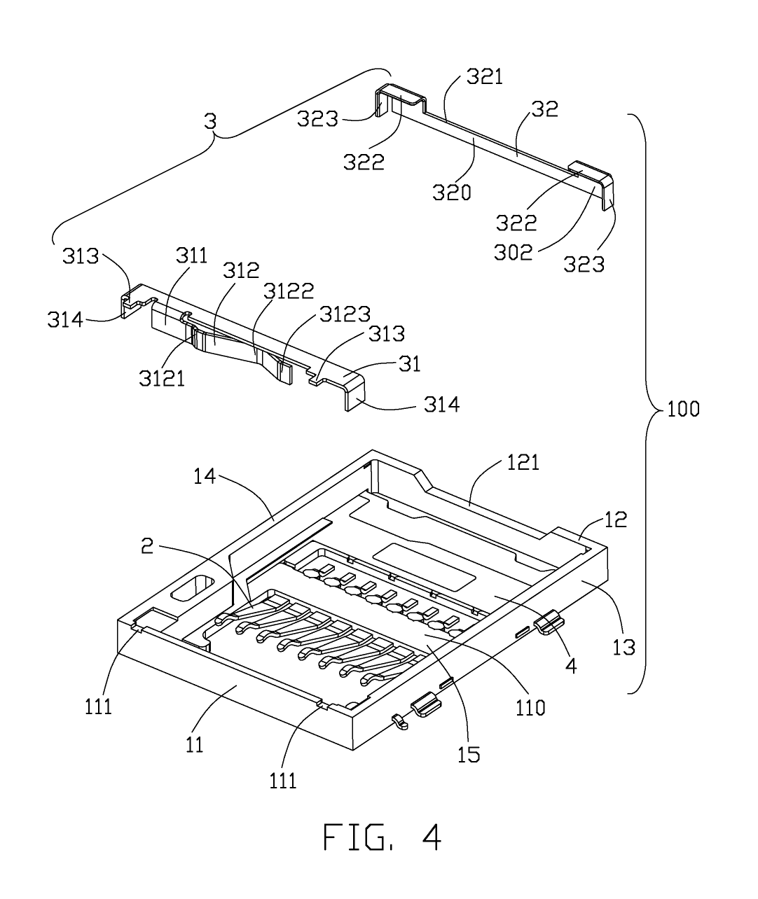

Reference will now be made to the drawing figures to describe the preferred embodiment of the present invention in detail. Referring to FIGS. 1-4, an electrical card connector 100 includes an insulative housing 1, a plurality of contacts 2 integrally molded in the insulative housing 1, a mounting member 3 disposed on the insulative housing 1 and a mounting plate 4.

The insulative housing 1 defines a receiving space 110 to receive an electrical card 200. The insulative housing 1 has a front wall 11, a rear wall 12, a left side wall 13, a right side wall 14 and a bottom wall 15, which surround the receiving space 110. The receiving space 110 has an opening for insertion of the electrical card 200. The front wall 11 is located at a same height with the rear wall 12. The bottom wall 15 connects the left and right side walls 13, 14. A top of the front wall 11 comprises two mounting slots 111 symmetrically passing through the front wall 11 and the rear wall 12, and extending along a front-to-back direction. A passageway slot 121 depresses downwardly from a middle of the rear wall 12 and connects with the receiving space 110. User puts finger in the passageway slot 121 and pushes the electrical card 200 to eject the electrical card 200 therefrom.

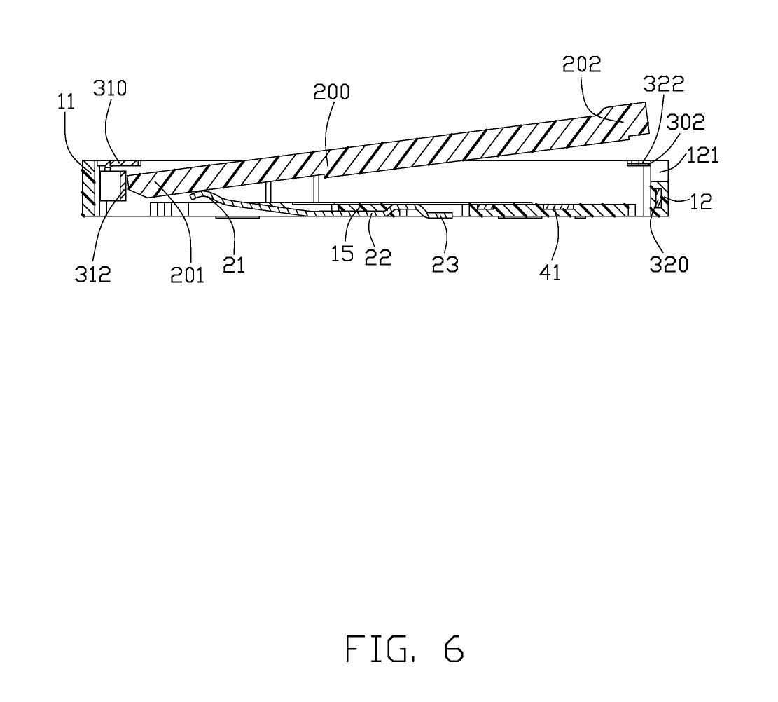

Please refer to FIG. 6, each of the contacts 2 comprises a retaining portion 22 integrally molded in the bottom wall 15, a soldering portion 23 extending backwardly and located outside of the bottom wall 15, and a contacting portion 21 extending forwardly from the retaining portion 22 and disposed in the receiving space 110 for contacting with a contact pad of the electrical card 200.

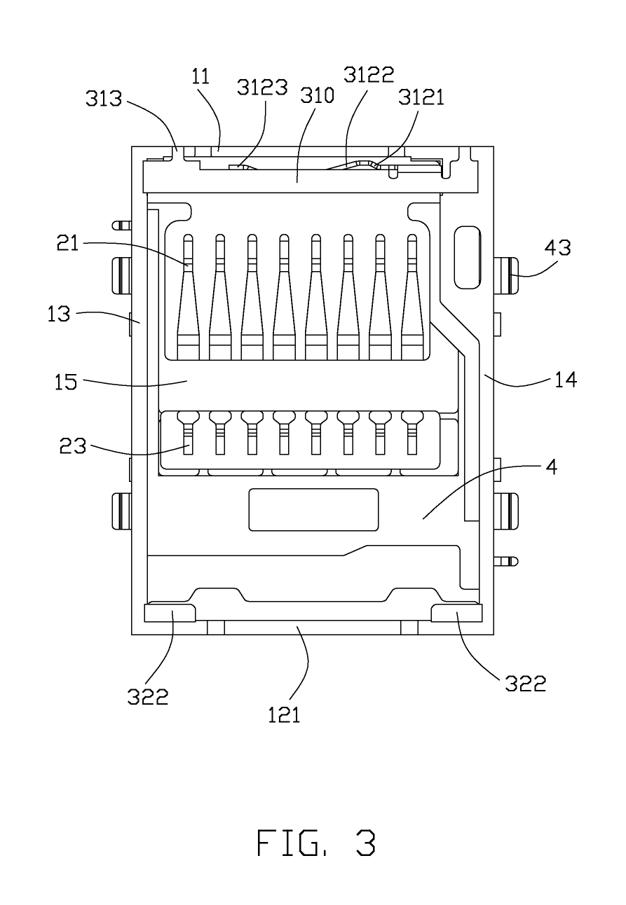

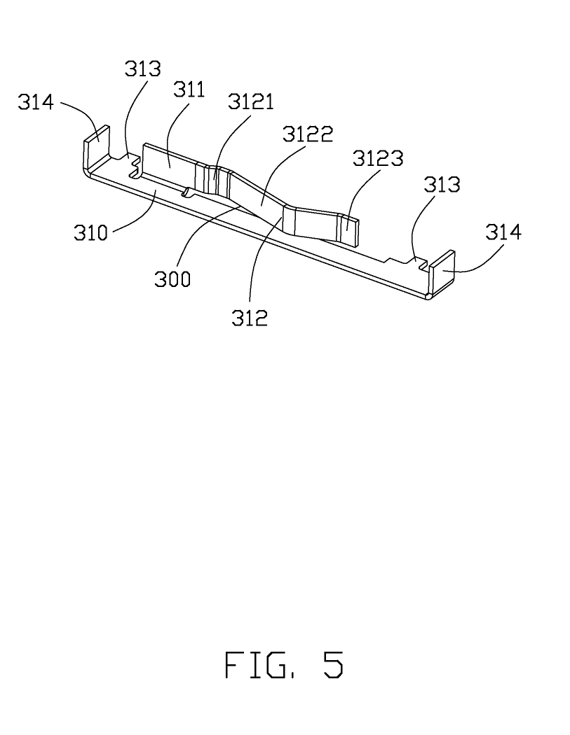

Please refer to FIGS. 3-5, the mounting member 3 comprises a first metal plate 31 covering a front of the receiving space 110 and a second metal plate 32 covering a rear of the receiving space 110. The first metal plate 31 has a rectangular-shaped first top wall 310 which has the same height of the front wall 11, a mating portion 311 extending downwardly and vertically from a front edge of the first top wall 310, an arc-shaped elastic plate or spring/resilient arm 312 extending towards left from the mating portion 311 and forming a front accommodating space 300 with the top wall 310, two symmetrical dowel beams 313 extending forwardly from the first top wall 310 and insert molded in the mounting slot 111 to retain the first metal plate 31, and two first retaining arms 314 inclining downwardly from two sides of the first top wall 310 and insert molded in a front of the left and right side wall 13, 14 to fix the first metal plate 31.

The elastic plate 312 is disposed in the receiving space 110 and has a first pressing portion 3121 extending forwardly and deflect from the mating portion 311, an arc-shaped elastic portion 3122 extending backwardly and bent from the first pressing portion 3121, and a second pressing portion 3123 extending forwardly and bent from the elastic portion 3122. The first and second pressing portions 3121, 3123 stretch forwardly beyond the mating portion 311 and abut against an inside of the front wall 11. The first and second portions 3121, 3123 are located under the first top wall 310. The front accommodating space 300 is located in a rear of the elastic plate 312 and in a bottom of the first top wall 310.

The second metal plate 32 has a back plate 320 insert molded in the rear wall 12, a cutout 321 passing through a central of the back plate 320, two second top walls 322 extending forwardly and vertically from two opposite ends of a top edge of the back plate 320, and two second retaining arms 323 extending downwardly from two outsides of the second top walls 322.

The second top walls 322 cover the rear of the receiving space 110. A bottom edge of the cutout 321 is hidden in the rear wall 12. The second retaining arms 323 are insert molded in a rear of the left and right side walls 13, 14 to retain the second metal plate 32. The second top wall 322 is at the same height of the rear wall 12 and forms a rear accommodating space 302 between them.

The mounting plate 4 comprises a body portion 41 embedded in the bottom wall 15 and two soldering tails 43 extending outside from the left and right side walls 13, 14 respectively to connect with the grounding traces in a printed circuit board on which the electrical card connector to is mounted. The mounting plate 4 and the contacts 2 are formed from a same metal plate.

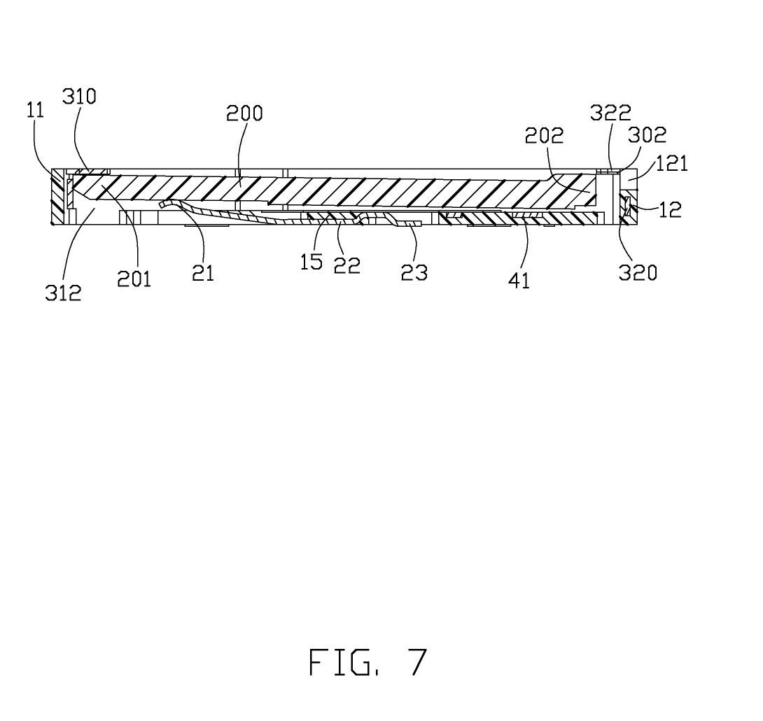

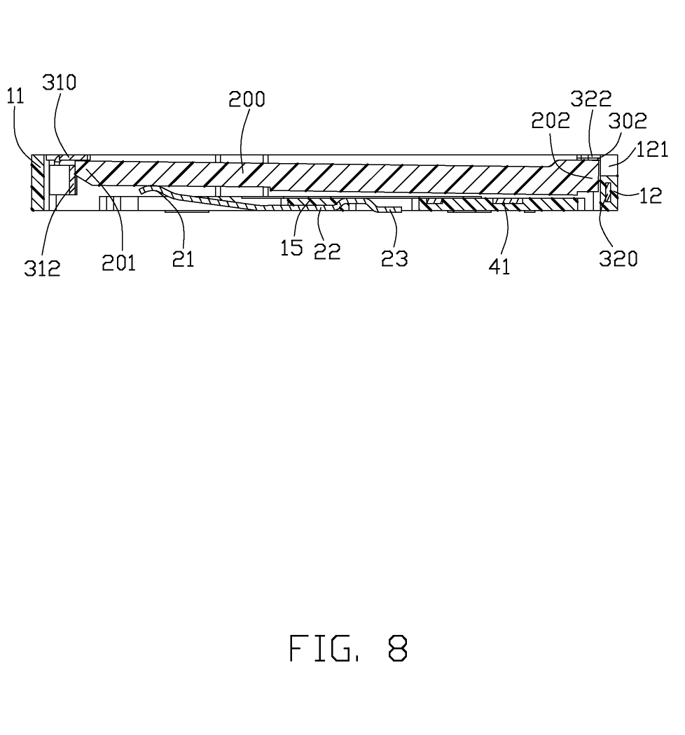

Please refer to FIGS. 6-8, When the electrical card 200 is inserted into the electrical card connector 100. At first, a front portion 201 of the electrical card 200 is inserted into the accommodating space 300 by fingers. The front portion 201 resists the elastic portion 3122 of the elastic plate 312 forwardly and cause deformation of the elastic portion 3122, the first and second pressing portions 3121, 3123 lean against the front wall 11. Then, the rear portion 202 of the electrical card 200 is pressed downwardly into the receiving space 110 to make the rear portion 202 to be inserted into the receiving space 110. In the end, the electrical card 200 is backwardly pushed into the rear accommodating space 302 by fingers and resilience of the elastic portion 3122. The first top wall 310 of the first metal plate 31 prevents the front portion 201 from moving upwardly and the elastic portion 3122 prevents the front portion 201 from moving forwardly. The second top wall 322 of the second metal plate 32 prevents the rear portion 202 from moving upwardly and the rear wall 12 prevents the rear portion 202 from moving backwardly.

When the electrical card 200 is ejected from the electrical connector 100. User pushes the rear portion 202 of the electrical card 200 forwardly until the rear portion 202 separates from the rear accommodating space 302 so as to eject the electrical card 200 out off the receiving space 110 with the help of the elastic force of the elastic plate 312.

The elastic plate 312 is bent downwardly from the first metal plate 31 to abut backwardly against the electrical card 200 during the insertion of the electrical card 200 into the receiving space 110 for positioning and locating the electrical card 200 and providing force when ejecting the electrical card 200 from electrical card connector 100.

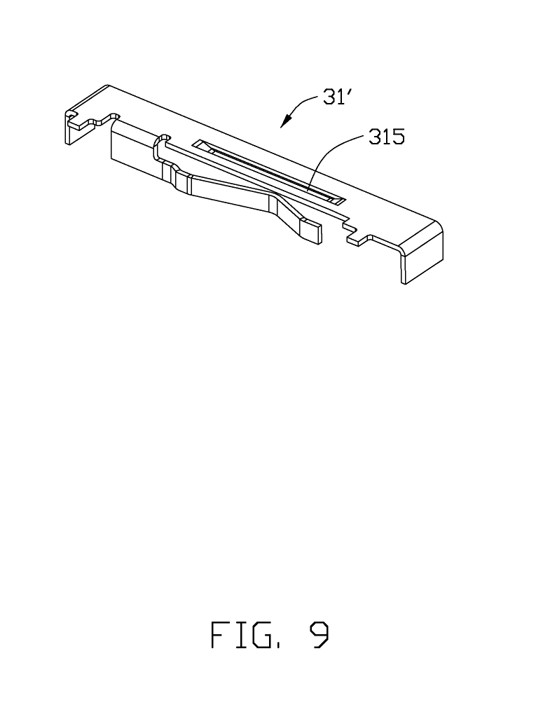

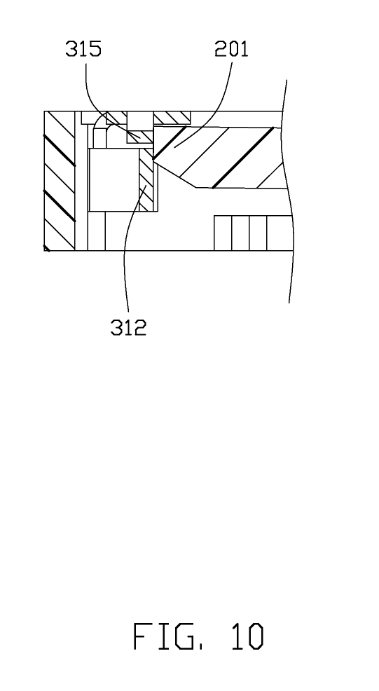

FIGS. 9 and 10 disclose another embodiment in which the substitute first metal plate 31′ further includes an additional downward extending stationary abutment piece 315 by stamping for abutting against the front portion 201 of the electrical card 200 when the electrical card is located at the final position so as to solidly prevent the electrical card from forward moving. Understandably, compared with the first embodiment without this stationary abutment piece 315, the second embodiment requires an affirmative downward force imposed upon the electrical card to disengage the front portion 201 of the electrical card 200 from the stationary abutment piece 315 during withdrawing the electrical card 200 from the receiving space 110, thus preventing inadvertent withdrawal of the electrical card 200 from the connector 100 due to any unexpected external vibration

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical card connector comprising:
an insulative housing having a receiving space for receiving an electrical card and a front wall located in front of the receiving space;
a plurality of contacts retained in the insulative housing, each of contacts comprising a contacting portion extending into the receiving space and a soldering portion extending out of the insulative housing; and
a mounting member comprising a first metal plate retained to the insulative housing, the first metal plate having an elastic plate disposed in a front of the receiving space and extending backwardly in the receiving space for resisting a front portion of the electrical card.

2. The card connector as claimed in claim 1, wherein the elastic plate is located adjacent the front wall, and the elastic plate leans against the front wall when the electrical card abuts against the elastic plate.

3. The card connector as claimed in claim 1, wherein the elastic plate comprises a first pressing portion, an arc-shaped elastic portion extending backwardly and bent from the first pressing portion and a second pressing portion extending forwardly and bent from the elastic portion, all of the first and second pressing portions and the elastic portion are disposed in the receiving space.

4. The card connector as claimed in claim 3, wherein the first metal plate comprises a first top wall covering a front of the receiving space and a mating portion extending downwardly and vertically from the a front edge of the first top wall to connect the elastic plate, the first and second pressing portions stretch forwardly beyond the mating portion to abut against an inside of the front wall.

5. The card connector as claimed in claim 3, wherein a front accommodating space is defined between the elastic plate and the first top wall, the front accommodating space is located in a rear side of the elastic plate and a bottom side of the first top wall.

6. The card connector as claimed in claim 4, wherein the mounting member comprises a second metal plate having a back plate and a second top wall extending vertically and forwardly from a top of the back plate, the second top wall covers a rear of the receiving space for abutting against the rear of the electrical card, a rear accommodating space is defined between the second top wall and a rear wall of the insulative housing for receiving a rear of the electrical card.

7. The card connector as claimed in claim 6, wherein the first top wall of the first metal plate has the same height as that of the second top wall of the second metal plate, and the first top wall has the same height as that of the front wall, the second top wall has the same height as that of the rear wall.

8. The card connector as claimed in claim 6, wherein the insulative housing comprises a left side wall, a right side wall and a bottom wall connecting the left side wall and the right side wall, the top of the front wall comprises two mounting slots symmetrically passing through the front wall along a front-to-back direction to engage with the first metal plate, a passageway slot is depressed downwardly from a middle of the rear wall and communicates with the receiving space, the back plate is insert molded in the rear wall and defines a cutout corresponding to the passageway slot, a bottom edge of the cutout is hidden in the rear wall.

9. The card connector as claimed in claim 6, wherein the first metal plate comprises two first retaining arms extending downwardly from two sides of the first top wall and two dowel beams extending forwardly from the first top wall, the second metal plate comprises two second retaining arms depressing from two sides of the second top wall, the first and second retaining arms are insert molded in the left and right side walls, respectively, the dowel beams are insert molded in the front wall.

10. The card connector as claimed in claim 8, wherein the card connector comprises a mounting plate having a body portion and two soldering tails extending from two sides of the body portion, the body portion is insert molded in the bottom wall, the mounting plate and the contacts are formed from a same metal plate.

11. An electrical card connector for use with an electrical card, comprising:
an insulative housing defining a mating face thereon;
a plurality of contacts disposed in the housing with resilient contacting sections extending beyond the mating face to be deflectable in a vertical direction;
a frame structure associated with the housing to cooperate with the housing to commonly define therebetween a card receiving space which is large enough for receiving a card therein in both lengthwise and transverse directions which are perpendicular not only to each other but also commonly to the vertical direction, said frame structure defining a front section around a front part of the receiving space and a rear section around a rear part of the receiving space under condition that an opening defined between the front section and the rear section of the frame structure, through which the electrical card is installed into or withdrawn from the receiving space, is smaller than a lengthwise of the electrical card in the lengthwise direction while is not lees than the width of the electrical card in the transverse direction so as to have the electrical card retained in the receiving space without possibility of dropping-out in the vertical direction; wherein
a frame structure is further equipped with a resilient device around the front section for constantly providing a rearward force upon the electrical card in the receiving space under condition that the receiving space is dimension to allow the electrical card to be moved between a front position where the electrical card is ready for insertion thereinto or withdrawal therefrom in a tilted manner, and a rear position where the electrical card is adapted to be stably received in the receiving space via urging forces from the contacting section in the vertical direction and that from the resilient device in the lengthwise direction and restraint from the front section and the rear section at least in the vertical direction.

12. The electrical card connector as claimed in claim 11, wherein the frame structure is discrete from the housing.

13. The electrical card connector as claimed in claim 12, where said frame structure is made from metal.

14. The electrical card connector as claimed in claim 11, wherein the frame structure further includes a stationary abutment piece for confronting a front edge of the electrical card when said electrical card is located in the rear position.

15. The electrical card connector as claimed in claim 14, wherein both the abutment piece and the resilient device abut against the electrical card when the electrical card is located at the rear position in the receiving space.

16. The electrical card connector as claimed in claim 11, wherein the rear section provides restraint in the lengthwise direction while the front section does not except the resilient device.

17. A method of installing an electrical card into an electrical card connector, comprising steps of:
providing an electrical card connector with an insulative housing having contacts therein, said contacts defining contacting sections deflectable in a vertical direction;
providing a frame structure upon the housing to cooperate with the housing to commonly define a card receiving space which the contacting sections extend into and which is dimensioned to allow the electrical card to move between opposite front and rear positions in a lengthwise direction perpendicular to said vertical direction while said frame structure defines an opening, through which the electrical card is installed into or withdrawn from the receiving space, is smaller than the electrical card in the lengthwise direction; and
providing a resilient device around a front part of the receiving space to constantly urging the electrical card rearward when the electrical card is located in the receiving space; wherein
the electrical card is allowed to be installed into the receiving space via the opening in a tilted manner with thereof a front edge initially being downwardly pointed and inserted into the front part of the receiving space, successively with thereof a rear edge lowered into the receiving space to have the electrical card in generally a horizontal manner, and finally with the whole electrical card moved front the front position to the rear position under condition that the electrical card is applied with a force from the resilient devices in the lengthwise direction and those from the contacting sections in the vertical direction, and with restraint from the frame structure in the vertical direction.

18. The method of installing an electrical card into an electrical card connector as claimed in claim 17, wherein the frame structure is discrete from the housing and made of metal.

19. The method of installing an electrical card into the electrical card connector as claimed in claim 17, wherein said frame structure further defines a stationary abutment piece against which the front edge of the electrical card abuts when said electrical card is moved to the rear position.

20. The method of installing an electrical card into the electrical card connector as claimed in claim 17, wherein the resilient device is unitarily formed with the frame structure.
